(19) United States
(12) Patent Application Publication
(10) Pub. No.: US 2009/0255055 A1
(43) Pub. Date: Oct. 15, 2009

(54) PNEUMATICALLY OPERATED BELLOWS POP-UP ASSEMBLY FOR USE IN DRAINS

(76) Inventor: Scott E. Duncan, Santa Rosa, CA (US)

Correspondence Address: STAINBROOK & STAINBROOK, LLP, 412 AVIATION BOULEVARD, SUITE H, SANTA ROSA, CA, 95403, US

(21) Appl. No.: 12/420,271

(22) Filed: Apr. 8, 2009

Related U.S. Application Data
(60) Provisional application No. 61/044,037, filed on Apr. 10, 2008.

(51) Int. Cl. E03C 1/23; B08B 7/00

(52) U.S. Cl. 4/689; 137/15.01

(57) ABSTRACT

A drain stopper assembly for selectively opening and closing a drain located within a basin, tub or sink, the drain having an opening within said basin, tub or sink for facilitating the selective passage of water therethrough and passed its drain collar and drain body. A stopper is provided being selectively sealable on said drain collar allowing selective passage of water, bellows positioned within the drain body, an air supply in communication with the bellows being actuatable from a position exterior to the drain body for selective expansion and contraction of the bellows wherein an expansion of the bellows causes the stopper to separate from the drain collar and contraction of the bellows causes the stopper to seat upon the drain collar.

### RELATED APPLICATIONS

This application is based upon and claims priority to U.S. Provisional Patent Application No. 61/044,037 filed on Apr. 10, 2008

### TECHNICAL FIELD

The present invention relates generally to drain stoppers for basins, tubs and sinks and more particularly to apparatus for actuating up and down movement of a drain stopper, and still more particularly to a pneumatically operated bellows pop-up assembly for opening and closing the drain stopper and that allows for a complete removal of the drain stopper directly from the drain pipe without the use of tools.

### BACKGROUND OF THE INVENTION

Drain stoppers including lifting rods and linkage to drain assemblies have been employed for many years without any significant improvement. These assemblies generally include a ball rod assembly and linkage connecting the lift rod to the drain stopper including a pivot bar connected to the lower end of the lift rod which, in turn, is connected to a valve stem having a ball valve exposed inside a radially extending elbow within the drain body. As a lift rod is pulled upwardly, the drain stoppers moves downwardly to close the drain opening and as the drain rod is pushed downwardly, the chain stopper rises from the drain collar allowing the basin to drain accordingly.

In that the lift rod and pivot bar are linked to one another, it is extremely difficult to remove the drain stopper from its collar to clean the drain body. This linkage provides for a natural ledge which catches hail and other debris causing significant sanitary issues. In addition, such linkage oftentimes loosens reducing the control that a user has upon the orientation of the stopper by actuation of the lift rod. The linkage can oftentimes fail after repeated use and its repair requires the intervention of a plumber

It is thus an object of the present invention to provide a novel control device for selectively moving a stopper to block or open a drain collar without the need for complex linkages contained within the basin, tub or sink drain pipe.

It is yet a further object of the present invention to provide a novel installation in which a stopper can be removed from its supporting drain collar by merely lifting the stopper therefrom and without the need for disengaging complex linkages ordinarily found within such installation.

It is yet a further object of the present invention to provide a novel system which, upon removal of its stopper; provides a user within an unobstructed passage along the interior of the system's drain pipe for ease of cleaning and maintenance.

It is still a further object of the present invention to provide actuation of a stopper to selectively open and close a drain collar relying solely upon fluid pressure to expand and contract a bellows thus obviating the need for any of the complex linkage necessitated by the prior art.

It is yet still a further object of the present invention to provide a novel drain stopper assembly which can be installed without the use of tools or knowledge of complex plumbing considerations requiring only tubing and barb fittings to complete a typical installation.

### SUMMARY OF THE INVENTION

A drain stopper assembly for selectively opening and closing a drain located within a basin, tub or sink, the drain having an opening within said basin, tub or sink for facilitating the selective passage of water therethrough and passed its drain collar and drain body. A stopper is provided being selectively sealable on said drain collar allowing selective passage of water, bellows positioned within the drain body, an air supply in communication with the bellows being actuatable from a position exterior to the drain body for selective expansion and contraction of the bellows wherein an expansion of the bellows causes the stopper to separate horn the drain collar and contraction of the bellows causes the stopper to seat upon the drain collar.

### BRIEF DESCRIPTION OF THE FIGURES

FIG. 1 is a cross-sectional side view in elevation of the pneumatically operated bellows pop-up assembly of the present invention.

FIG. 2 is a cross-section side view in elevation showing detail of the connecting and operative elements of the pneumatic mechanism for raising and lowering the drain stopper of the present invention, and showing the drain in a lowered (drain blocked) position.

FIG. 3 is a cross-sectional side view in elevation thereof showing the drain raised by the pneumatically operated bellows

FIG. 4 shows the pneumatic elbow retracted from the drain body so that the drain stopper can be removed entirely from the main drain body

### DETAILED DESCRIPTION OF THE INVENTION

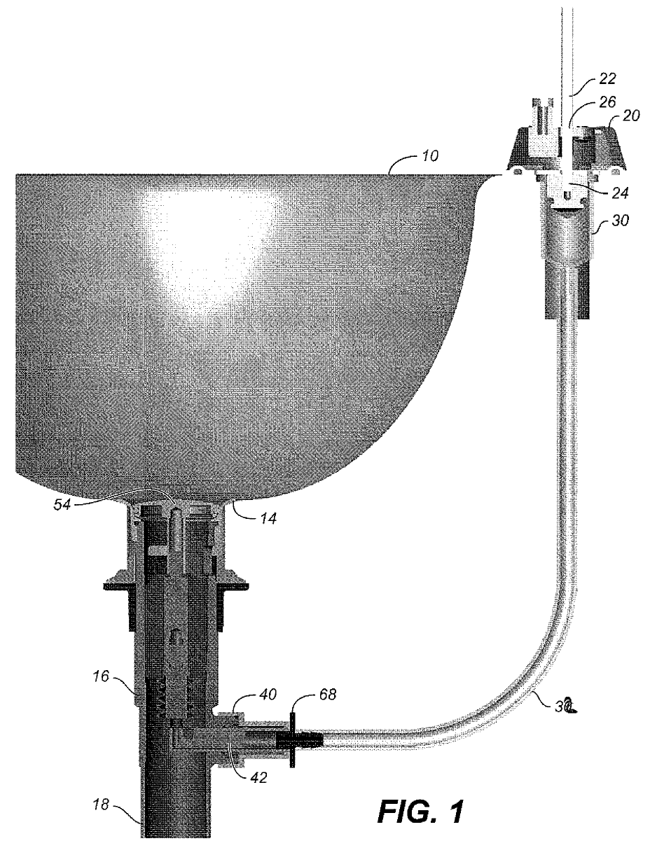

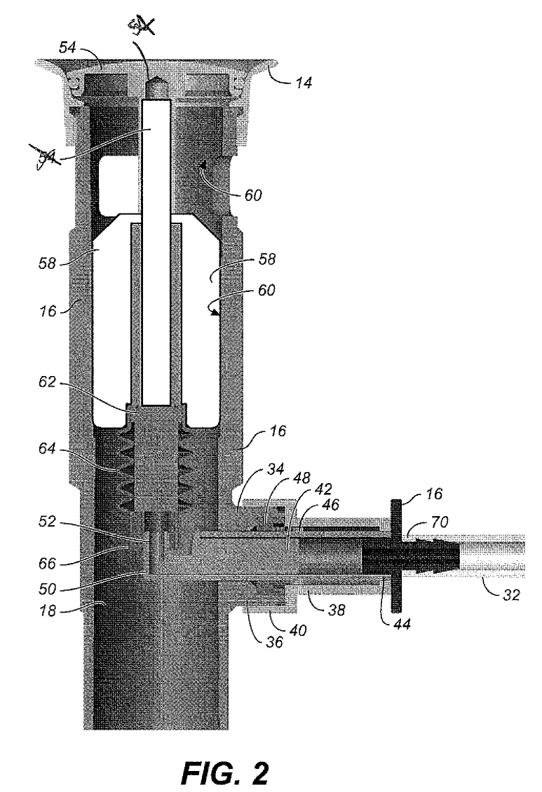

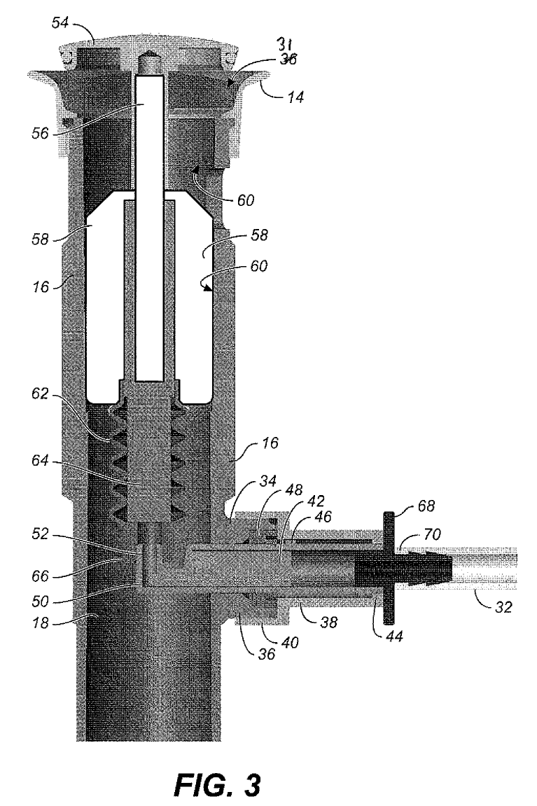

Referring first to FIGS. 1 through 4, wherein like reference numerals refer to like components in the various views, there is illustrated therein a new and improved sanitary quick-connect, pneumatically operated drain stopper apparatus. These views collectively show that the inventive apparatus is adapted for installation on a conventional sink, tub or basin 10 (and referred to generically as “basin” herein), the basin having bottom portion 12 with drain collar 14 disposed in the lowest area for draining fluids from the basin. The fluids pass through the drain collar, into and through drain body 16 and, in turn, through drain tailpiece 18, and then a trap for eventual routing to a sewer or septic system (not shown). The basin includes apron 20 with lifting rod 22 having lower end 24 slidably mounted through an installation opening 26. The lower end is connected to piston 29 slidably and sealingly disposed in air supply piston cylinder 30 for either putting air under pressure or releasing pressure in a closed system. An air tube 31 is connected to the piston cylinder and extends to a second piston chamber, described below.

As is found in most conventional drain assemblies, drain body 16 includes a radially extending elbow 31 having threaded male end 36.

In a conventional drain assembly, a mechanical linkage connects the lifting rod to the drain stoppers and this linkage includes a ball rod assembly and linkage connecting the lift rod to the drain stopper The ball rod assembly typically comprises a pivot bar connected to the lower end of the lift rod, which is, in turn, connected to a valve stem having a ball valve disposed inside the radially extending elbow on the drain body. The lift rod is pulled upwardly to move a drain stopper down to close drain opening 31.

Replacing the mechanical linkage of conventional drain assemblies, the present invention includes hollow cylindrical sleeve 38 having nut end 40 which is threadably installed on threaded male end 36 of radially extending elbow 34 of drain body 16. Slidably disposed within the cylindrical sleeve is aim 42 slidably journaled between distal seal 44 at the outer end of the cylindrical sleeve, medial seal 46 disposed in the central portion of the cylindrical sleeve, and proximal seal 48 disposed within the nut end of the cylindrical sleeve. Collectively, the seals prevent any water escaping the drain body though the cylindrical sleeve.

Arm 42 is hollow and includes upwardly turning elbow 50 terminating in open nipple 52 at its end.

The drain stopper portion of the present invention comprises stopper 54 having central connecting rod 56 depending downwardly from the stopper and including a plurality of fins 58 extending radially outward from the connecting rod to engage the interior side 60 of the main drain body 16.

Integrally connected to the lower end 62 of the connecting rod is expandable bellows 64 having fitting 66 at its lower end which makes a sealed press fit over the nipple 52 of the hollow arm 42. The other end of the arm is coupled to flanged hose barb 68, which is inserted in to the end 70 of the air hose 32. Thus, the bellows is in direct fluid communication with air supply piston cylinder 30, such that pulling lift rod 22 results in deflating the bellows and thereby allowing the drain stopper to depress and close and pulling the lift rod inflates the bellows and elevates the drain stopper into an open position.

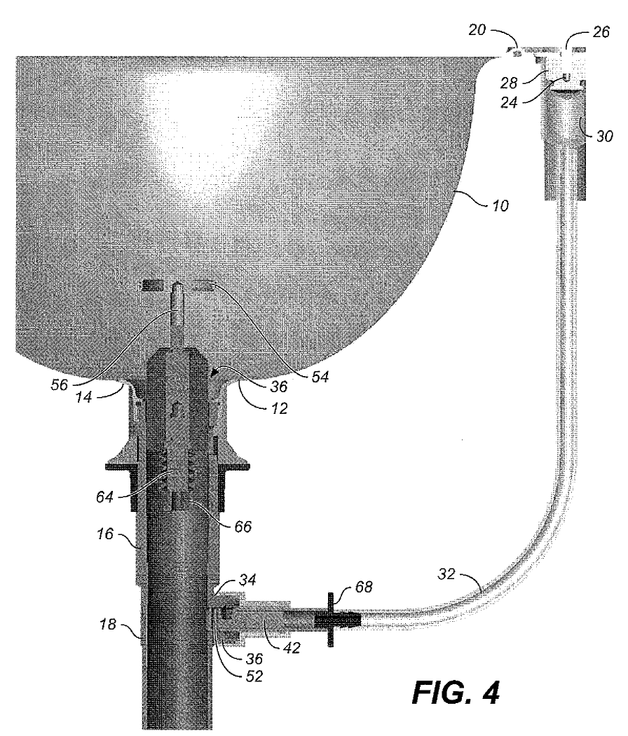

A distinct advantage of the present invention is the ease with which the drain stopper can be removed from the drain. It is simply lifted out, the only requirement being that sufficient pulling force be applied to release the press fit connection between coupling 66 on the bellows and nipple 52 on the arm. Once the stopper is removed, the aim can be retracted entirely from the main drain body by pulling the flanged hose barb outwardly, which results in the aim sliding between the various seals until it reaches a fully retracted position (see FIG. 4).

Another advantage of the present invention is that it can be employed in large volumes and on a large scale in buildings that have a supply of pressurized air. While the means of expanding the bellows shown herein is a closed system employing a first piston chamber, it will be immediately appreciated that the air line could easily be brought into fluid communication with a central air supply, and air would be provided or released from the expandable bellows by operating a valve. The valve could be actuated by a button, lever, rod, knob, or it could be an electric solenoid valve opened and closed by any of a number of well-known means, including voice activation. In such a way, the instant invention lends itself to installation in hotels, office buildings, hospitals, apartment buildings, and any kind of structure having a large number of sinks with drains.

The above discussion is intended to depict one of the embodiments for creating and operating the claimed drain stopper assembly although anyone skilled in this art would readily recognize alternative embodiments which are intended to be encompassed by the claims that follow. For example, although a lifting rod located upon an apron surrounding a typical basin, tub or sink is shown in actuating a cylinder, the bellows could equally be actuated through the use of an inert gas selectively introduced through the bellows assembly by any three way valve, toggle, push button or the like. Although the embodiment described above teaches the introduction of a gas to the bellows upon one pushing down upon a lifting rod, the same pump can draw air at its top or bottom depending upon one's preference thus the drain need not be “normally open” with bellow extended under pressure when the lifting rod is raised rather than lowered, the latter being industry standard. It is further noted that the faucet could be wall mounted with pressurized gas emanating from a source remote thereto thus enabling one to selectively open and close a stopper upon a drain collar without any direct mechanical linkage which would make the present invention the only drain that will operate on a wall mount or remote location.

The above disclosure is sufficient to enable one of ordinary skill in the art to practice the invention, and provides the best mode of practicing the invention presently contemplated by the inventor. While there is provided herein a full and complete disclose of the preferred embodiments of this invention, it is not desired to limit the invention to the exact construction, dimensional relationships and operation shown and described. Various modifications, alternative constructions, change and equivalents will readily occur to those skilled in the art and may be employed, as suitable, without departing from the true spirit and scope of the invention. Such changes might involve alternative materials, components, structural arrangements, sizes, shaped, forms, functions, operational features or the like.

Therefore, the above description and illustrations should not be construed as limiting the scope of the invention, which is defined by the appended claims.

What is claimed is:

1. A chain stopper assembly for selectively opening and closing a drain located within a basin, tub or sink, said drain having an opening within said basin, tub or sink for facilitating the selective passage of water therethrough passed a drain collar and drain body, a stopper being selectively sealable on said drain collar allowing selective passage of water therethrough, bellows positioned within said drain body, an air supply in communication with said bellows being actuatable from a position exterior to said drain body, for selective expansion and contraction of said bellows wherein expansion of said bellows causes said stopper to separate from said drain collar and contraction of said bellows causes said stopper to seat upon said drain collar.

2. The drain stopper assembly of claim 1 further comprising a lifting pedestal having a first end and second end, said first end appended to said stopper and said second end appended to said bellows, said lifting pedestal being slidable within said drain body in response to the actuation of said bellows.

3. The drain stopper assembly of claim 1 further comprising an elbow radially extending from said drain body.

4. The drain stopper assembly of claim 3 further comprising a hollow cylindrical sleeve sized to fit within and be received by said elbow.

5. The drain stopper assembly of claim 4 further comprising an arm slidably journaled within said hollow cylindrical sleeve.

6. The drain stopper assembly of claim 5 wherein said arm is further characterized as having an upward turning elbow in fluid communication with said bellows.

7. The drain stopper assembly of claim 6 wherein said drain stopper and bellows are removable from said drain body by lifting said stopper from said drain collar.

8. The drain stopper assembly of claim 7 wherein said arm is fully retractable from the interior of said drain body.

9. The drain stopper assembly of claim 7 wherein the interior of said drain body is unobstructed upon removal of said drain stopper, bellows and arm.

10. The drain stopper assembly of claim 1 further comprising a piston, moveable within a piston cylinder for selectively expanding and contracting said bellows.

11. The drain stopper assembly of claim 10 further comprising a lifting rod for moving said piston within said piston cylinder.

12. The drain stopper assembly of claim 11 comprising an apron surrounding said basin, tub or sink for supporting said lifting rod.

13. A drain stopper assembly for selectively opening and closing a drain located within a basin, tub or sink, the drain having an opening within said basin, tub or sink for facilitating the selected passage of water therethrough passed a drain collar and drain body, the stopper being selectively sealable on said drain collar allowing selective passage of water therethrough, said stopper being supported by a lifting pedestal slidably located within said drain body, bellows positioned within said drain body appended to said lifting pedestal, an air supply in communication with said bellows being actuatable from a positioned exterior to said drain body for selective expansion and contraction of said bellows wherein expansion of said bellows causes said stopper to separate from said drain collar and contraction of said bellows causes said stopper to seat upon said drain collar, an elbow radially extending from said drain body, a hollow cylindrical sleeve sized to fit within and be received by said elbow, an arm slidably journaled within said hollow cylindrical sleeve having an upward turning elbow and fluid communication with said bellows wherein said drain stopper and bellows are removable from said drain body by lifting said stopper from said drain body whereupon said aim is fully retractable from the interior of said drain body.

14. The drain stopper assembly of claim 13 further comprising a piston, movable within a piston cylinder for selectively expanding and contracting said bellows.

15. The drain stopper assembly of claim 14 further comprising a lifting rod for moving said piston within said piston cylinder.

16. The drain stopper assembly of claim 15 further comprising an apron surrounding said basin, tub or sink for supporting said lifting rod.

17. A method of cleaning a drain body in fluid communication with a drain located within a basin, tub or sink, the drain having an opening within said basin, tub or sink for facilitating the passage of water passed a drain collar and drain body, a stopper selectively sealable on said drain collar allowing for the selective passage of water therethrough, said stopper being supported by a lifting pedestal slidably located within said drain body, providing bellows positioned within said drain body and an air supply in communication with said bellows being actuatable from the position exterior to said drain body for selective expansion and contraction of said bellows wherein expansion of said bellows causes said stopper to separate from said drain collar and contraction of said bellows causes said stopper to seat upon said drain collar, further providing an elbow radially extending from said drain body, a hollow cylindrical sleeve sized to fit within and be received by said elbow and an aim slidably journaled within said hollow cylindrical sleeve, removing said drain stopper, lifting pedestal and bellows by grasping said stopper and lifting it together with the lifting pedestal and bellows away from said drain collar, withdrawing said arm from the interior of said drain body through said elbow and passing a blush within the interior of said drain body.
